(19) United States
(12) Patent Application Publication
(10) Pub. No.: US 2025/0167370 A1
(43) Pub. Date: May 22, 2025

(54) BATTERY HOLDER AND ELECTRIC MACHINE

(71) Applicant: FANUC CORPORATION, Minamitsuru-gun, Yamanashi (JP)

(72) Inventor: Hideyuki WATANABE, Yamanashi (JP)

(73) Assignee: FANUC CORPORATION, Minamitsuru-gun, Yamanashi (JP)

(21) Appl. No.: 18/841,429

(22) PCT Filed: May 27, 2022
(86) PCT No.: PCT/JP2022/021698

§ 371 Date: Aug. 26, 2024

(51) Int. Cl. H01M 50/244

(52) U.S. Cl. CPC H01M 50/244; H01M 2220/10

(57) ABSTRACT

A battery holder that retains a backup battery for an encoder of an electric machine driven by a servo motor; and is removably fixed to an inner surface in an internal space of the electric machine, the internal space being sealed by a cover that can open and close an opening section of an outer wall of the electric machine. The battery holder includes: a battery accommodation section that accommodates the battery and allows the battery to be removed when the opening section is open; and a partition wall disposed outside the battery accommodation section. The partition wall blocks an access route that passes through the opening section and reaches components which can be put into an active state by energization of the servo motor.

### TECHNICAL FIELD

The present disclosure relates to a battery holder and an electric machine.

### BACKGROUND

An electric device driven by a servo motor includes a rotary encoder that detects and stores rotation angle position information for a shaft of the servo motor. The electric device has a backup battery mounted thereon, so as not to lose the position information when power is not supplied thereto (for example, see Japanese Unexamined Utility Model Application, Publication No. 5-67490).

In a state of being accommodated in a battery holder with a lid, the battery is inserted into an internal space of the electric device from an opening section provided in an outer wall of the electric device. The battery holder inserted into the opening section is fixed to the outer wall of the electric device, in which the opening section is provided, thereby blocking the opening section.

At the time of battery replacement etc., if the battery is removed in a state in which the power source of the electric device is turned off, the position information of the rotary encoder is lost. Thus, usually, the battery replacement work is performed with the electric device being energized. At this time, an operator needs to avoid touching energized components etc. With a structure in which the opening section is blocked by the battery holder, battery replacement is allowed while avoiding touching energized components etc.

On the other hand, in order to facilitate assembly or maintenance of a component in the internal space, an opening section that enables the internal space to be widely opened is provided in the outer wall of the electric device, in some cases. A large opening section is generally provided separately from a small opening section for the battery holder, and is opened and closed when a larger cover is detached and attached.

### SUMMARY

One aspect of the present disclosure is a battery holder that retains a backup battery for an encoder of an electric machine driven by a servo motor and that is detachably fixed to an inner surface in an internal space of the electric machine, the internal space being sealed by a cover capable of opening and closing an opening section of an outer wall of the electric machine, the battery holder comprising: a battery accommodation section that accommodates the battery and that allows the battery to be removed in a state in which the opening section is open; and a partition wall that is provided outside the battery accommodation section, wherein the partition wall blocks an access route that passes through the opening section and that reaches a component that can be put into an active state by energization of the servo motor.

### BRIEF DESCRIPTION OF DRAWINGS

FIG. 1 is a side view showing an electric machine according to one embodiment of the present disclosure.

FIG. 2 is a partial longitudinal sectional view showing a battery holder according to the embodiment of the present disclosure, the battery holder being mounted in the electric machine shown in FIG. 1.

FIG. 3 is a partial side view showing a state in which a cover for the electric machine shown in FIG. 2 is removed.

FIG. 4 is a side view showing the battery holder shown in FIG. 2.

FIG. 5 is a longitudinal sectional view showing the battery holder shown in FIG. 4.

FIG. 6 is a partial side view showing a state in which the battery holder is removed from the electric machine shown in FIG. 3.

FIG. 7 is a partial longitudinal sectional view showing a modification of the electric machine shown in FIG. 2.

### DETAILED DESCRIPTION OF EMBODIMENTS

A battery holder and an electric machine 1 according to one embodiment of the present disclosure will be described below with reference to the drawings.

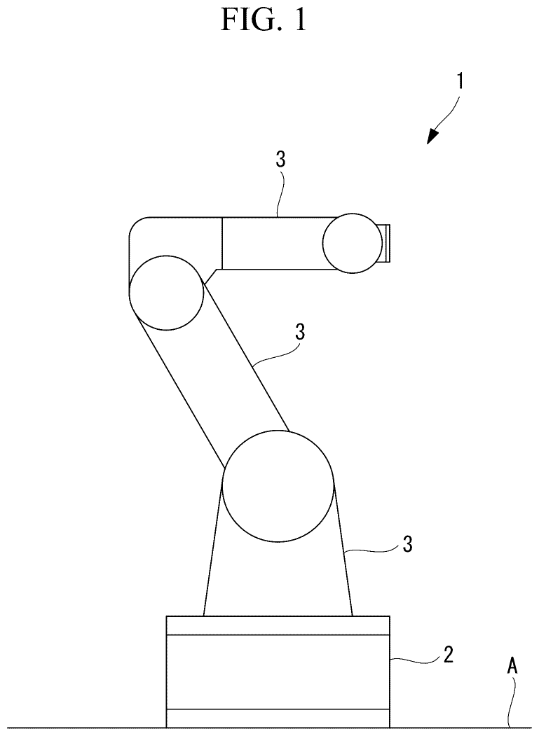

As shown in FIG. 1, the electric machine 1 of this embodiment is a robot (hereinafter, also referred to as robot 1).

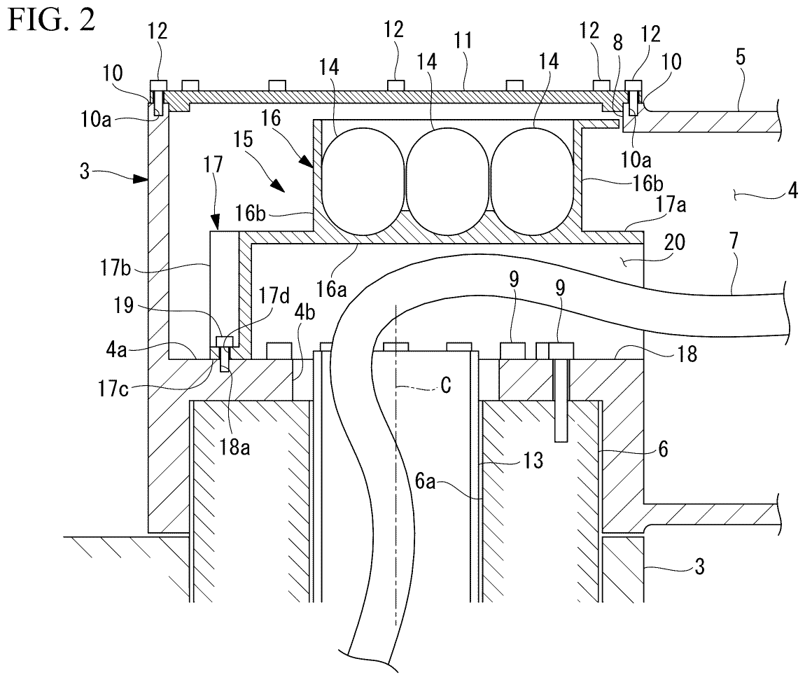

The robot 1 according to this embodiment includes a base 2 that is installed on an installation surface A, such as a floor surface, and one or more movable parts 3, such as arms, that can be moved with respect to the base 2. The base 2 and the individual movable parts 3 are formed in hollow shapes and each have an outer wall 5 that defines an internal space 4, as shown in FIG. 2.

The robot 1 includes one or more servo motors (not shown) for driving the movable parts 3. Each of the servo motors is disposed inside the internal space 4 or outside the outer wall 5 of the base 2 or each of the movable parts 3. Furthermore, the internal spaces 4 of the base 2 and the movable parts 3 each accommodate a machine component, such as a reduction gear 6 for decelerating the rotation of a shaft of the servo motor, for example. Furthermore, the internal spaces 4 each accommodate a cable 7 for supplying electricity and signals to the servo motor.

Each of the servo motors rotates the shaft with the supply of electricity from a control device (not shown) and generates heat through energization.

Furthermore, the machine component, such as the reduction gear 6, can be moved inside the internal space 4 through the operation of the servo motor. Furthermore, a current flows in the cable 7 when the servo motor is driven.

That is, the states of the servo motor, the machine component such as the reduction gear 6, and the cable 7 can change depending on the presence/absence of the supply of electricity to the servo motor. Therefore, the servo motor, the machine component such as the reduction gear 6, and the cable 7 are components that can be put into an active state by energization. Furthermore, in addition to the reduction gear 6, components that can be operated inside the internal space 4 by the servo motor are all components that can be put into an active state by energization.

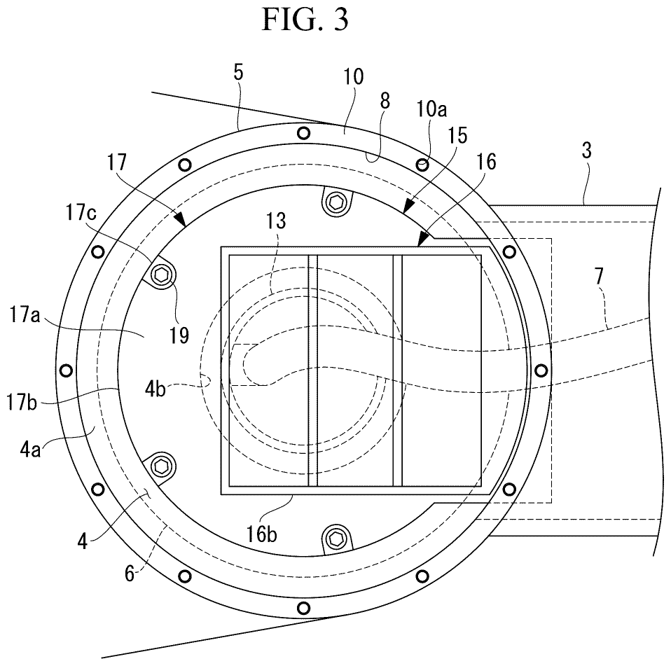

A description will be given of an example case in which an opening section 8 that communicates with the internal space 4 and the outside is formed in the outer wall 5 of the movable part 3, as shown in FIGS. 2 and 3. The opening section 8 is as large as the outer shape of the reduction gear 6, for example, in order to allow fastening of bolts 9 for fixing the reduction gear 6 in the internal space 4.

A seat surface 10 is formed all around a peripheral edge of the opening section 8, as shown in FIG. 3, and a plurality of screw holes 10a are formed in the seat surface 10 along the circumferential direction thereof. The robot 1 includes a cover 11 that blocks the opening section 8 so as to be opened and closed.

The cover 11 can be detachably attached to the outer wall 5 by means of bolts 12 that are fastened into the screw holes 10a in the seat surface 10. A seal member (not shown) is disposed between the seat surface 10 and the cover 11. The cover 11 is fixed to the seat surface 10 of the outer wall 5 by means of the bolts 12, thereby making it possible to tightly close the opening section 8 in a liquid-tight state.

The reduction gear 6 has, for example, a hollow hole 6a penetrating therethrough along the central axis thereof, in the vicinity of an axis line C. The cable 7 passes through the hollow hole 6a, for example, and is wired into the inside of the internal space 4 of the movable part 3 from the adjacent base 2 or another movable part 3.

A resin cylindrical body 13 is disposed inside the hollow hole 6a, and the cable 7 is made to pass through the inside of the cylindrical body 13, whereby the cable 7 is protected from contact with the reduction gear 6. The cylindrical body 13 is fixed to a movable section of the reduction gear 6, for example, and is rotationally operated with respect to the movable part 3 through the operation of the servo motor. Therefore, the cylindrical body 13 is also a component that can be put into an active state by energization.

In the example shown in FIG. 2, since the reduction gear 6 is disposed outside the internal space 4, a large section of the reduction gear 6 does not correspond to a component that can be put into an active state by energization. The movable section of the reduction gear 6, which is exposed to the internal space 4 via a through-hole 4b through which the cylindrical body 13 is made to pass, corresponds to a component that can be put into an active state by energization.

The cable 7 is fixed, inside the internal space 4, to a guide plate (not shown) by a nylon band (not shown) or the like so as to form a desired wiring route.

The servo motor includes a rotary encoder (hereinafter, referred to as encoder) (not shown) that detects and stores rotation angle position information on the shaft. When the power source of the control device is turned on, the encoder is supplied with electricity sent via the cable 7 and retains the rotation angle position information without losing it.

On the other hand, when the power source of the control device is not turned on, the above-described supply of electricity to the encoder via the cable 7 is stopped. In this case, the encoder is supplied with electricity from a backup battery 14 to keep retaining the rotation angle position information.

As shown in FIGS. 2 and 3, the robot 1 of this embodiment includes a battery holder 15 disposed in an accommodated state inside the internal space 4 of the movable part 3.

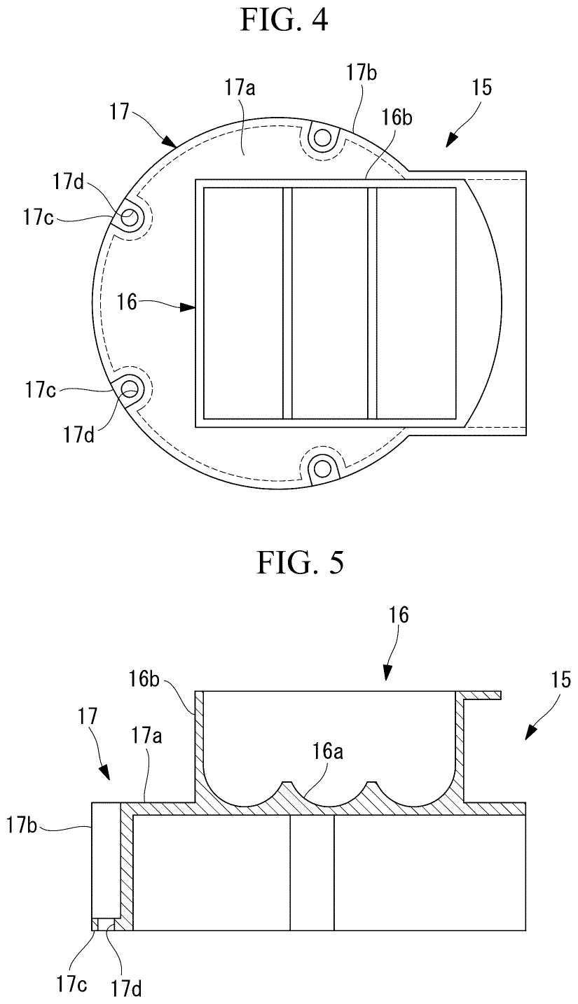

As shown in FIGS. 4 and 5, the battery holder 15 of this embodiment includes a battery accommodation section 16 and a partition wall 17.

The battery accommodation section 16 is formed into a box shape having a bottom surface 16a and four side walls 16b connected to the bottom surface 16a, and accommodates one or more batteries 14 therein.

The partition wall 17 includes a flat plate section 17a extending from outer surfaces of the side walls 16b of the battery accommodation section 16 in directions in which the bottom surface 16a of the battery accommodation section 16 extends. Furthermore, the partition wall 17 includes a peripheral wall section 17b extending from an outer peripheral edge of the flat plate section 17a in a direction that intersects the flat plate section 17a.

The battery accommodation section 16 and the partition wall 17 are integrally manufactured by injection-molding an electrically insulating resin material, for example. The peripheral wall section 17b includes attachment sections 17c that are brought into close contact with a seat surface 18 provided in an inner surface 4a of the internal space 4 of the movable part 3. The attachment sections 17c include through-holes 17d.

The seat surface 18 is provided in the inner surface 4a of the internal space 4, the inner surface 4a being located at a position facing the opening section 8, and includes a plurality of screw holes 18a. In order to fix the battery holder 15 to the movable part 3, the attachment sections 17c are brought into close contact with the seat surface 18, and bolts 19 made to penetrate through the through-holes 17d are fastened into the screw holes 18a.

When the battery holder 15 is fixed to the movable part 3, the bottom surface 16a of the battery accommodation section 16 and the partition wall 17 cover the through-hole 4b of the movable part 3 and the cable 7. Accordingly, the battery accommodation section 16 and the partition wall 17 block an operator's access route that passes through the opening section 8 and that reaches the hollow hole 6a and the cable 7. Here, blocking the access route means blocking or narrowing the space so as to prevent a hand of the operator inserted via the opening section 8 from passing through the space.

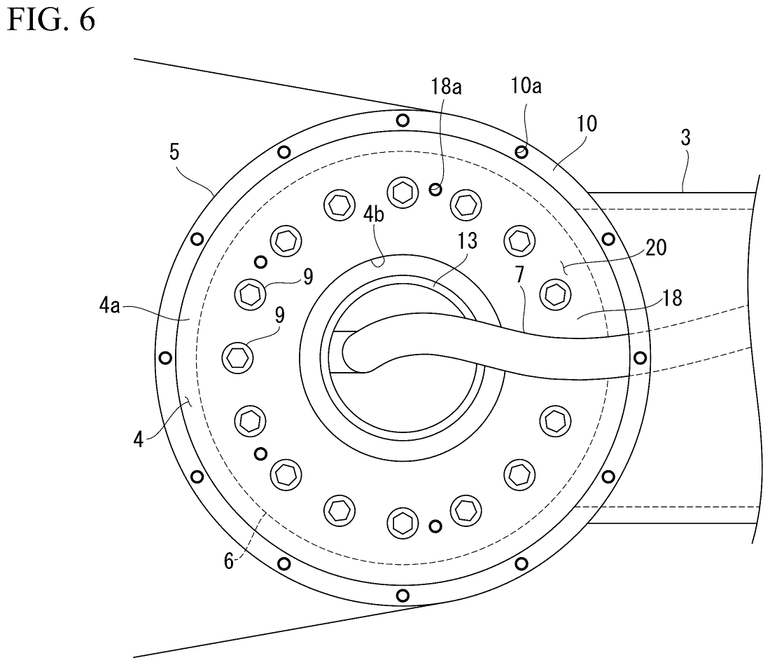

FIG. 6 shows a state in which the battery holder 15 is not fixed inside the internal space 4. In this state, the bolts 9 for fixing the reduction gear 6, the cylindrical body 13, and the cable 7 are exposed at positions where the operator can freely come in contact with them. Therefore, the operator can easily perform attachment/detachment of the bolts 9 for the reduction gear 6 or handling work of the cable 7, by using the wide opening section 8.

When the battery holder 15 is fixed to the inner surface 4a, the battery accommodation section 16, the partition wall 17, and the inner surface 4a define an isolated space 20, as shown in FIG. 2. The isolated space 20 is located at the opposite side from the opening section 8 with the battery accommodation section 16 and the partition wall 17 being sandwiched therebetween. Then, the hollow hole 6a, the cylindrical body 13, and the cable 7 are disposed inside the isolated space 20. Accordingly, the partition wall 17 of the battery holder 15 blocks a person's access route that passes through the opening section 8 and that reaches those components.

In this way, according to this embodiment, the battery holder 15 is fixed to the inner surface 4a of the internal space 4 in the robot 1, the internal space 4 being opened and closed by the cover 11. Accordingly, an opening section only for the battery holder 15 does not need to be provided in the outer wall 5, and a special seal structure is also unnecessary, whereby a simple structure can be achieved. Since the cover 11 needs to be provided at just one place, the number of components is reduced, and machining of the seat surface 10 is also reduced, whereby the costs can be reduced.

Furthermore, when the cover 11 is removed, the battery accommodation section 16 is located at a position closer to an operator than the isolated space 20 is, when viewed from the opening section 8. By just removing the cover 11 from the outer wall 5 of the movable part 3, it is possible to expose the battery 14 while covering the components 6, 7, 13, which can be put into an active state by energization.

That is, the cover 11 is removed to open the opening section 8 and to expose the battery accommodation section 16, thereby making it easy to replace the battery 14. At this time, the access route is blocked by the battery holder 15, thus making it possible to prevent the operator from accidentally touching the components 6, 7, and 13, which can be put into an active state by energization.

Furthermore, the isolated space 20 and the battery accommodation section 16 are disposed at positions so as to overlap with each other in the direction of the axis line C of the movable part 3. Accordingly, the isolated space 20 is not narrowed by the battery accommodation section 16, whereby the isolated space 20, in which the cable 7 is handled, can be widely secured. As a result, the area of the inner surface 4a required to install the battery holder 15 is reduced, thus making it possible to achieve miniaturization of the robot 1.

Furthermore, when the components 6 and 7, which can be put into an active state by energization, are assembled or maintained, the power source is cut off to stop energization. Therefore, the battery holder 15 is removed to form an access route, thus making it possible to easily perform work from the same opening section 8.

Note that, in this embodiment, the reduction gear 6, the cable 7, and the cylindrical body 13 have been shown as examples of components that can be put into an active state by energization. The reduction gear 6 includes: a static part that is not relatively displaced with respect to the inner surface 4a of the movable part 3; and a part that can be moved with respect to the static part. The static part does not need to be covered by the partition wall 17 of the battery holder 15. Furthermore, the servo motor, which generates heat by energization, or a gear etc. rotated by the servo motor may be included as a component that can be put into an active state by energization.

Furthermore, in this embodiment, although the robot 1 has been shown as an example of the electric machine, the present disclosure is not limited thereto. The present disclosure can be applied to an arbitrary electric machine 1 driven by a servo motor including an encoder.

Furthermore, in this embodiment, the isolated space 20 and the battery accommodation section 16 are disposed at positions so as to overlap with each other in the direction of the axis line C. Instead of this, the isolated space 20 and the battery accommodation section 16 may be disposed at positions in parallel in a direction perpendicular to the axis line C. Accordingly, the dimension of the battery holder 15 in the direction along the axis line C is reduced, thus making it possible to miniaturize the robot 1 in the direction of the axis line C.

Furthermore, in this embodiment, the partition wall 17, which has the peripheral wall section 17b, has been shown as an example. Instead of this, it is also possible that a peripheral wall section is provided on the side of the inner surface 4a of the movable part 3, and the partition wall 17 has only the flat plate section 17a.

Furthermore, an example case has been shown in which the partition wall 17 is formed integrally with the battery accommodation section 16. Instead of this, it is also possible that the partition wall 17 and the battery accommodation section 16 are separately formed and then fixed to each other by gluing or with screws etc.

Furthermore, although an example case has been shown in which the battery holder 15 is disposed inside the internal space 4 of the movable part 3, the battery holder 15 may be disposed inside the internal space of the base 2.

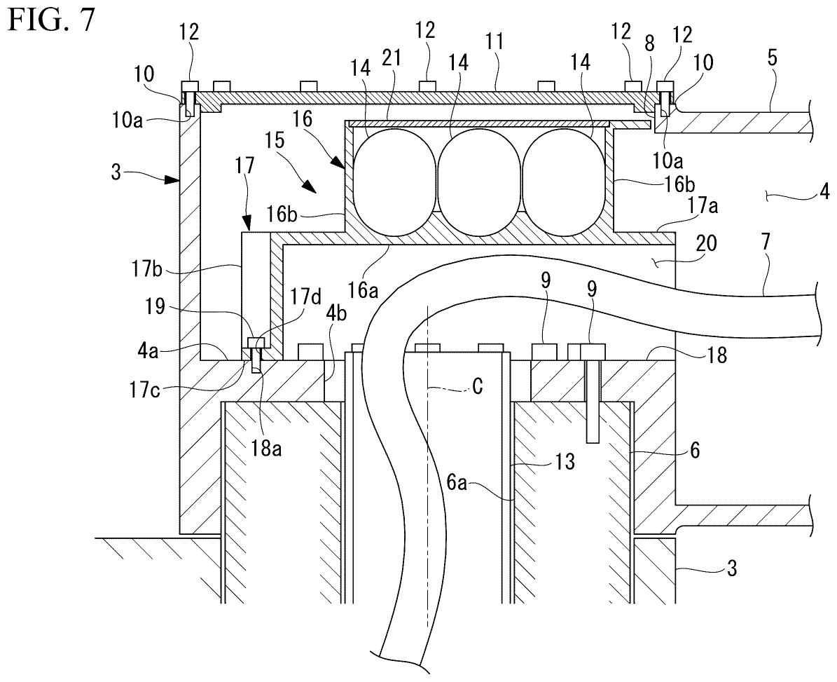

Furthermore, as shown in FIG. 7, it is also possible to include a lid body 21 that is detachably attached to the battery accommodation section 16. It is preferred that the lid body 21 is detachable with a simple mechanism such as a snap-fit mechanism, for example. The battery accommodation section 16 is closed by the lid body 21, thereby making it possible to more reliably prevent the battery 14 from falling off during the operation of the robot 1.

Instead of the lid body 21, an arbitrary falling-off prevention means such as a fixing belt (not shown) may be provided. It is preferred that the fixing belt is detachable with a simple mechanism such as a hook, for example.

Although embodiments of the present disclosure have been described above in detail, the present disclosure is not limited to the above-described individual embodiments. In these embodiments, various additions, replacements, modifications, and partial eliminations can be made without departing from the scope of the disclosure or without departing from the idea and the gist of the present disclosure derived from the content stated in the scope of claims and the equivalent thereof. For example, in the above-described embodiments, the order of operations and the order of processing procedures are shown as examples, and the present disclosure is not limited thereto. Furthermore, the same applies to a case in which a numerical value or a numerical expression is used in the description of the above-described embodiments.

1. A battery holder that retains a backup battery for an encoder of an electric machine driven by a servo motor and that is detachably fixed to an inner surface in an internal space of the electric machine, the internal space sealed by a cover configured for opening and closing an opening section of an outer wall of the electric machine, the battery holder comprising:
a battery accommodation section that accommodates the battery and that allows the battery to be removed in a state in which the opening section is open; and
a partition wall that is provided outside the battery accommodation section,
wherein the partition wall blocks an access route that passes through the opening section and that reaches a component that is configured to be put into an active state by energization of the servo motor.

2. The battery holder according to claim 1, wherein the component that can be put into an active state by energization is a cable for supplying electricity to the servo motor.

3. The battery holder according to claim 1, wherein the component that is configured to be put into an active state by energization is a machine component driven by the servo motor.

4. The battery holder according to claim 1, wherein a space where the component that is configured to be put into an active state by energization is disposed is located at an opposite side from the opening section with the battery accommodation section and the partition wall being sandwiched therebetween.

5. The battery holder according to claim 1, wherein a space where the component that is configured to be put into an active state by energization is disposed is located at an opposite side from the opening section with the partition wall around the battery accommodation section being sandwiched therebetween.

6. The battery holder according to claim 1, further comprising a lid body that opens and closes the battery accommodation section.

7. An electric machine comprising:
an outer wall that forms an internal space;
a cover that can open and close an opening section provided in the outer wall;
a component, at least part of which is disposed inside the internal space, and is configured to be put into an active state by energization; and
a battery holder according to claim 1.
